(19) United States
(12) Patent Application Publication
(10) Pub. No.: US 2006/0250613 A1
(43) Pub. Date: Nov. 9, 2006

(54) Method and applications to enhance and image optical signals from biological objects

(75) Inventors: Joseph Demuth, Naples, FL (US); Patrick J. Treado, Pittsburgh, PA (US); John S. Maier, Pittsburgh, PA (US); David Tuschel, Monroeville, PA (US)

Correspondence Address: Daniel H. Golub, 1701 Market Street, Philadelphia, PA, 19103, US

(73) Assignee: Chem Image Corporation, Pittsburgh, PA (US)

(21) Appl. No.: 11/404,964

(22) Filed: Apr. 14, 2006

Related U.S. Application Data
(60) Provisional application No. 60/671,397, filed on Apr. 14, 2005.

(51) Int. Cl. G01J 3/44; G01N 21/65

(52) U.S. Cl. 356/301

(57) ABSTRACT

A method and apparatus for imaging biological objects. A SERS surface is provided having enhancing structures uniformly distributed on the surface. The surface includes a two dimensional area of at least 5×105 nm. The enhancing structures may have a size, in at least one dimension of height, width and length, ranging from 100 nm to 1000 nm. A biological material is deposited on the SERS surface. The biological material on the SERS surface is illuminated using a monochromatic light source producing Raman scattered photons. The Raman scattered photons are filtered using a tunable filter into a plurality of predetermined wavelength bands. A two-dimensional array detector detects the filtered Raman scattered photons, in a spatially accurate manner. The results of filtering and detecting steps are combined to produce a plurality of spectrally resolved Raman images of the biological material.

### RELATED APPLICATIONS

This application claims the benefit of U.S. Patent Application No. 60/671,397 filed Apr. 14, 2005 entitled “Method and Applications to Enhance and Image Optical Signals from Biological Objects” which is incorporated herein by reference in its entirety.

### FIELD OF DISCLOSURE

The present disclosure relates to Raman imaging using surface enhanced Raman spectroscopy substrates.

### BACKGROUND

Surface Enhanced Raman Spectroscopy (“SERS”) is an interesting phenomenon, but it is neither well understood, nor reproducible, nor controllable. Most understanding and SERS work is currently performed on small metal particles to enhance the Raman signal. Currently SERS is applied to enhance the Raman signals of relatively small molecules on surfaces and not large biological entities. Originally SERS was created on electrochemically roughened noble metal surfaces which proved hard to characterize and reproduce. Most of the more recent SERS work involves use of small, 20-200 nm diameter, colloidal particles of Ag or Au due to ease of fabrication and reproducibility. In some cases these particles are treated so that a ligand is attached which acts to bind it to a particular chemical entity. In cases of biological samples, such ligands are referred to as immuno tags which can bind to a well defined protein or receptor in the biological sample. Such tagging is widely used in other medical fields as well but depends on the specific targeted object, thereby preventing this from being a general method to study any material or target entity.

SERS studies have been largely limited by the small size of the SERS probe which has typically been comprised of nano-particles or structures that provide an enhancement at or nearby the structures, typically within nanometers from such structures but as much as five nanometers from the structures. Most SERS and the phenomenology to understand and direct the design of SERS substrates or targets have been based on the desire to maximize the resulting signal from specific molecules not the spatial localization of the enhancement nor the uniformity of the enhancement of the biological objects. Most cases of large SERS require the molecules to be directly bound to the SERS surface thereby allowing new electronic states and optical transitions that lead to strong polarization of the molecule/surface (or particle) complex. It is also known that the local electromagnetic fields are enhanced by small particles or by the creation of localized static fields or “plasmons” in free electron like metals such as Ag or Au, either as small particles, or aggregates of small particles. Designed physical Ag or Au structures such as gratings or arrays are known to couple the incident electromagnetic field to the object to produce resonant field enhancements associated with the plasmons of these structures. These enhanced fields give rise to enhancement of the Raman signal that is combined with any shorter range chemical enhancement. In many cases of small particles, these plasmon fields are very confined and give rise to large SERS enhancements.

The SERS phenomena has been widely studied and has been implemented in numerous ways, for example using Noble metals of Ag and Au in electrochemically roughened surfaces, colloidal particles, sol gels, grating surfaces, microarrays of deposited material, overcoatings on latex spheres and nanofibers, novel material nano-fabrication approaches, lithographically formed nano-arrays and even photonic crystal arrays to name a few. To date, a wide range of results are purported citing various high levels of Raman enhancement of 10⁷ to 10¹⁴.

SERS studies of biological entities include the introduction of small nano-particles into cells that may attach to some intracellular biological materials, attachment of colloidal particles to biological objects in solution, disruption of the cell to expose cellular content to the SERS active sites of a substrate or the combined use of antibody-active SERS particles with both antibody and SERS ligands. Such SERS labeled immuno-tagged particles could allow Raman scattering intensities that rival fluorescent tags, with the advantage that Raman would enable many more tags to be detected at one time than possible with fluorescent tags. The drawback of this latter approach for Raman-tagged assays is that immuno-labeling is a reagent based system, i.e., not general, and dependent on having the right immuno-tags and the right chemistry to bond both tag and Raman ligand on the same particle. It is also limited by the need to know the identity of the target material and have an appropriate immunoassay to attach to the target material in the biological object.

### SUMMARY

The present disclosure provides for a method for imaging biological objects. A SERS surface is provided having a plurality of enhancing structures distributed on the surface wherein the surface includes a two dimensional area of at least 5×10⁵ nm². A biological material is deposited on the SERS surface. The biological material on the SERS surface is illuminated, via a monochromatic light source, producing Raman scattered photons. The Raman scattered photons are filtered using a two-dimensional tunable filter, in a plurality of predetermined wavelength bands. A two-dimensional array detector detects the filtered Raman scattered photons, in a spatially accurate manner. The results of filtering and detecting steps are combined to produce a plurality of spatially accurate wavelength resolved Raman images of the biological material. In one embodiment, the enhancing structures are uniformly distributed over the surface. In another embodiment, the enhancing structures have a size, in at least one dimension of height, width and length, ranging from 100 nm to 1000 nm.

In one embodiment, the biological material on the SERS surface is illuminated along a first optical path producing Raman scattered photons, along a second optical path, wherein the first optical path is at an oblique angle with respect to the second optical path.

In another embodiment, the steps of illuminating, filtering and detecting are repeated at a plurality of focus depths generating a plurality of outputs. The output is combined to construct a volumetric image of said biological material deposited on the SERS surface.

In yet another embodiment, the SERS surface is supported on a transparent substrate.

The present disclosure further provides for a method for imaging biological objects. A SERS surface is provided having one of the following: a plurality of nanostructures uniformly distributed on the surface and a plurality of mesostructures uniformly distributed on the surface. A biological material is deposited on the SERS surface. A reagent is provided between the biological material and the SERS surface. The biological material on the SERS surface is illuminated, via a monochromatic light source, producing Raman scattered photons. The Raman scattered photons are filtered using a two-dimensional tunable filter, in a plurality of predetermined wavelength bands. A two-dimensional array detector detects the filtered Raman scattered photons, in a spatially accurate manner. The results of filtering and detecting steps are combined to produce a plurality of spatially accurate wavelength resolved Raman images of the biological material.

The present disclosure further provides for a method for imaging objects. A SERS surface is provided having a plurality of enhancing structures distributed on the surface wherein the surface includes a two dimensional area of at least 5×10⁵ nm². A material is deposited on the SERS surface where the material has at least one dimension of length or width of at least 600 nm. The material on the SERS surface is illuminated, via a monochromatic light source, producing Raman scattered photons. The Raman scattered photons are filtered using a two-dimensional tunable filter, in a plurality of predetermined wavelength bands. A two-dimensional array detector detects the filtered Raman scattered photons, in a spatially accurate manner. The results of filtering and detecting steps are combined to produce a plurality of spatially accurate wavelength resolved Raman images of the material. In one embodiment, the enhancing structures are uniformly distributed over the surface. In another embodiment, the enhancing structures have a size, in at least one dimension of height, width and length, ranging from 100 nm to 1000 nm.

The present disclosure provides for an apparatus used as a diagnostic probe placed on a sample such as tissue, organ or body part. The apparatus includes a monochromatic light source, a plurality of optical fibers, a SERS surfaces, a two dimensional tunable filter, a two dimensional detector and a processor. The optical fibers transmit substantially monochromatic light to a sample and receive Raman scatter photons produced by the sample. The SERS surfaces are located on the exterior of the substrate. The SERS surface has enhancing structures distributed on the surface which includes a two dimensional area of at least 5×10⁵ nm² and the enhancing structures have a size, in at least one dimension of height, width and length, ranging from 100 nm to 1000 nm. A two dimensional tunable filter filters the Raman scattered photons in a plurality of predetermined wavelength bands. A two dimensional detector detects the filtered Raman scattered photons, in a spatially accurate manner, and generates outputs in response to the Raman scattered photons in a plurality of predetermined wavelength bands. A processor combines the outputs of the two dimensional detector to produce a plurality of spatially accurate wavelength resolved Raman images of the sample.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

In the drawings:

FIG. 1 illustrates an exemplary system used in connection with the present disclosure;

FIG. 2 illustrates an exemplary system used in connection with the present disclosure;

FIG. 3 illustrates an exemplary system used in connection with the present disclosure;

FIG. 4 illustrates an exemplary SERS surface having meso-structures uniformly distributed across the surface;

FIG. 5 illustrates biological entities distributed on an exemplary SERS surface having meso-structures uniformly distributed across the surface;

FIGS. 6A and 6B illustrate a simulation of Raman enhancement for short range enhancement and long range enhancement;

FIG. 7 illustrates an exemplary device of the present disclosure;

FIG. 8 illustrates an exemplary system used in connection with the present disclosure; and

FIG. 9 is a flow chart illustrating an embodiment of the present disclosure.

### DESCRIPTION OF THE EMBODIMENTS

Reference will now be made in detail to the embodiments of the present disclosure, examples of which are illustrated in the accompanying drawings. Wherever possible, the same reference numbers will be used throughout the drawings to refer to the same or like parts.

This disclosure provides for a SERS surface having enhancing structures distributed over the surface wherein the surface includes a two dimensional area of at least 5×10⁵ nm². In one embodiment the enhancing structures have a size, in at least one dimension of height, width and length, ranging from 100 nm to 1000 nm. The surface is used for the deposition and detection of biological objects having enhanced Raman scattering. The disclosure further provides for methods to produce a plurality of spectrally resolved images and a plurality of spatially resolved spectra, having an enhanced Raman signal, of the biological material deposited on the enhancing structures SERS surface. The uniform SERS surface will enhance the Raman signal 100-1000 times, in a manner which is uniform over an area and extends significantly further away from the surface so as to obtain spatially accurate Raman images of large biological objects. The methods of this disclosure will permit significantly faster spatially resolved Raman imaging from biological objects than previously possible. The imaging will be performed without the need for chemical tagging of the molecular components in the biological object.

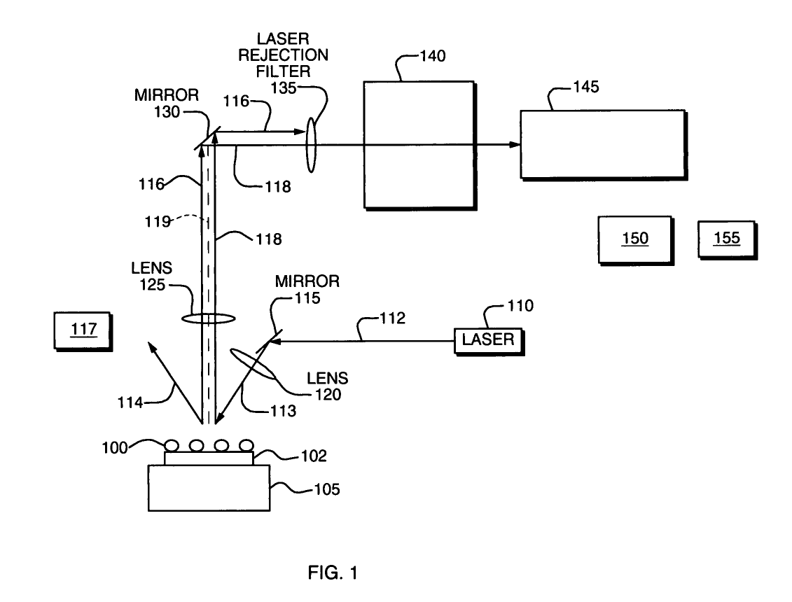

FIG. 1 illustrates one embodiment of a system which may be used to carry out the methods of the present disclosure. Sample 100 is deposited on a uniformly structured SERS surface 102 positioned on substrate 105. Light source 110 illuminates sample 100 with a plurality of photons resulting in Raman photons scattered from the sample. Light source 110 can include any conventional photon source, including laser, LED, and other IR or near IR devices. Light source 110 may also be oriented or selected to provide evanescence illumination of the sample.

In one embodiment, the monochromatic light source 110 is positioned to provide incident light along a first optical path 113, which is at an angle to sample 100, as opposed to light shining orthogonal to sample 100, as illustrated in FIG. 1. In other words, the radiation used to illuminate the sample need not pass through the optical train of a conventional microscope (or macroscope); rather, it can illuminate the sample at an oblique angle from above or below sample 100. Photon beam 112 is received and deflected by mirror 115 through lens 120. Lens 120 may optionally be used to focus the light on sample 100. Alternatively, the photon beam 112 may be directed towards the sample 100 without the need for the mirror 115.

The multitude of photons in beam 112 reaching sample 100 illuminate the sample and are scattered from different locations on or within the sample. Scattered photons are schematically represented as beams 116 and 118 while specularly reflected photons are represented schematically as beam 114. The scattered photons are produced along a second optical path 119, wherein the first optical path 113 is at an oblique angle with respect to the second optical path 119.

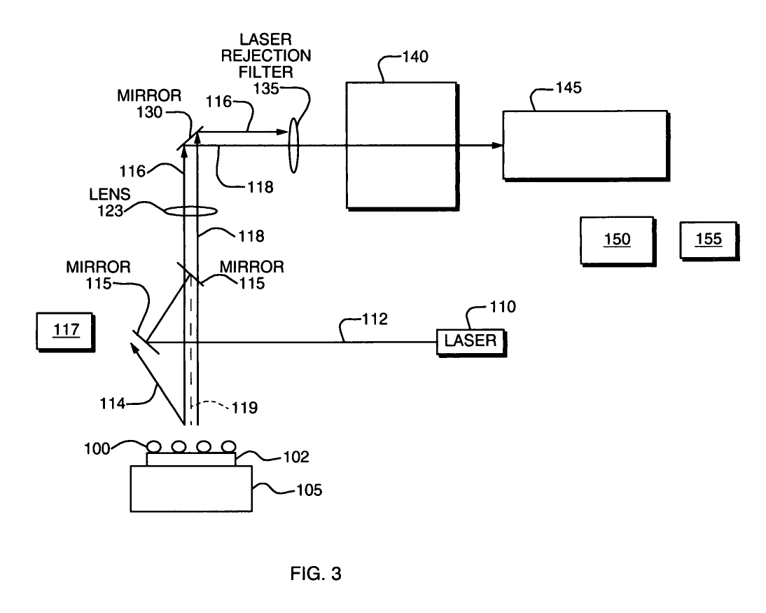

FIG. 3 illustrates another embodiment of a system used to carry out the methods of the present disclosure. The monochromatic light source 110 is positioned to provide incident light along optical path 119 which is orthogonal to sample 100. The incident light used to illuminate the sample passed through the optical train of a conventional microscope. Scattered photons are schematically represented as beams 116 and 118 which are produced along optical path 119.

Referring to FIG. 1, optical lens 125 is positioned along the second optical path 119 to collect scattered photons. Optical lens 125 may be used for gathering and focusing received photon beams. This includes gathering and focusing both polarized and un-polarized photons. The focus depth may be changed by varying the location of optical lens 125 relative to sample 100. In general, the sample size and desired magnification determine the choice of light gathering optical lens 125. For example, a microscope lens may be employed for analysis of sub-micron to micrometer specimens. For larger samples, macro lenses can be used. Optical lens 125 (as well as lens 120) may include a simple reduced resolution/aberration lens with a larger numerical aperture to thereby increase the system's optical throughput and efficiency. Mirror 130 is positioned to direct scattered photon beams 118 to tunable filter 140. It should be noted that placement of mirror 130 is optional and may be unnecessary in configurations where the tunable filter is positioned above sample 100.

Laser rejection filter 135 may be positioned prior to tunable filter 140 to filter out elastic scattered illumination light represented by beam 116 and to optimize the performance of the system. In other words, rejection filter 135 enables spectral filtering of the photons at the illuminating wavelength.

With further reference to FIG. 1, a filter 140 passes the scattered photons into a plurality of predetermined wavelength bands. The filter 150 may include a tunable filter corresponding, for example, to an electro-optical tunable filter, liquid crystal tunable filter (“LCTF”), an acousto-optical tunable filter (“AOTF”), a Fabry Perot angle tuned filter, a Lyot filter, an Evans split element liquid crystal tunable filter, a Solc liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, and a liquid crystal Fabry Perot tunable filter. The filter 140 is positioned in the second optical path 119. The plurality of predetermined wavelength bands include specific wavelengths or ranges of wavelengths. In one embodiment, the predetermined wavelength bands include wavelengths characteristic of the sample undergoing analysis. The wavelengths that can be passed through filter 140 may range from 200 nm (ultraviolet) to 2000 nm (i.e., the near infrared). The choice of filter depends on the desired optical region and/or the nature of the sample being analyzed. The filer is selected to operate in one or more of the following spectral ranges: the ultraviolet (UV), visible, and near infrared.

In another embodiment, the filter may include a two dimensional grating disperser which includes a hologram grating. The hologram grating is fabricated using E-beam fabricated lithography. Grating may be fabricated to achieve spectral wavelength resolution in the visible, UV, infrared or near-infrared wavelength range. The grating is fabricated to achieve spectral resolution over a Raman Shift value in a spectra range of 2800 cm⁻¹ to 3200 cm^{31 1} corresponding to the carbon-hydrogen stretching modes. In a second embodiment, the grating 108 is fabricated to achieve spectral resolution over a Raman Shift value in the fingerprint region corresponding to a spectra range of 500 cm⁻¹ to 2000 cm⁻¹. Computed Tomography Imaging Spectroscopy (“CTIS”) used as a spectral imaging tool is described in U.S. patent application Ser. No. 11/336,588 entitled “Method for Raman Computer Tomography Imaging Spectroscopy,” which is incorporated herein by reference in its entirety.

A first two-dimensional array of detection elements 145 (“first detector”) detects filtered Raman scattered photons in a spatially accurate manner to generate output to processor 150. The first detector may include a digital device such as an image focal plane array (“FPA”) CCD or CMOS sensor. The optical region employed to characterize the sample of interest governs the choice of the first two-dimensional array detector. For example, a two-dimensional array of silicon charge-coupled device (“CCD”) detection elements can be employed for image analysis with visible wavelength fluorescence and Raman spectroscopy, while gallium arsenide (GaAs) and gallium indium arsenide (GaInAs) FPA detectors can be employed for image analyses at near infrared wavelengths. The choice of such devices depends on the type of sample being analyzed. The first detector 145 detects, in a spatially accurate manner, the scattered photons passed by the tunable filter 140. In one embodiment, each detection element in the first two-dimensional array of detection elements used to form the detection array 145 functions to detect photons scattered from a different spatial location on or within the sample. In one embodiment, the first two-dimensional array of detection elements 145 produces digital images of the entire view of the sample as processed by tunable filter 140.

A second two-dimensional array of detection elements 117 (“second detector”) may include a digital device such as for example CCD or CMOS sensor to detect reflected photons.

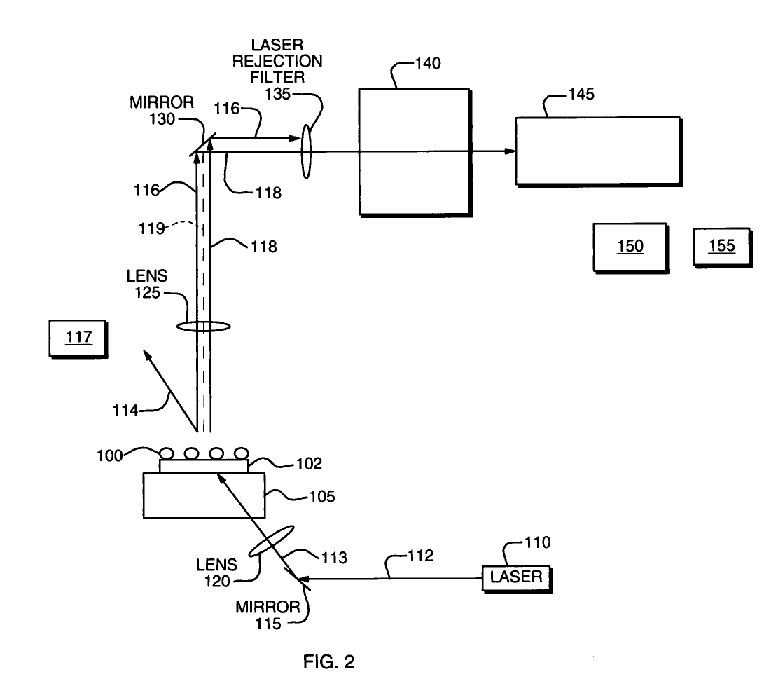

FIG. 2 schematically represents a system according to yet another embodiment of the disclosure. More specifically, FIG. 2 schematically shows a high optical throughput configuration for imaging using low light levels at variable magnification. The collection of optics is similar to that illustrated in FIG. 1, but with illumination from the underside of sample 100.

It is noted that in both FIGS. 1 and 2, sample 100 is illuminated at an oblique angle. Specifically referring to FIG. 2, photon beam 13 and the plane axis of sample 100 define an oblique angle. It has been found that through oblique illumination, a so-called “Dark Field Raman Imaging” is developed. As opposed to the conventional bright field Raman configuration, the dark field Raman imaging decouples the image capture optics from the delivery of exciting radiation. Consequently, internal scattering and attenuation of the incident radiation has been minimized to improve the signal to noise ratio. Also, the location of the optical source external to the optical train further allows the use of a lower cost, less powerful illumination source as well as enables a simpler, less expensive integration of several illumination sources into the system. In addition, it allows for coupling of the illumination beam into devices such as waveguides, integrated optics and microfluidic devices.

In each of the embodiments shown in FIGS. 1, 2, and 3 at least one processor 150 is coupled to and used to control the optical devices of the apparatus illustrated in FIGS. 1 and 2, including lenses 120, 125, 135, mirrors 115, 130, tunable filter 140, first detector 145 and second detector 117. Processor 150 combines the results from the tunable filter 140 and the first detector 145 to generate a plurality of spatially resolved Raman spectra and/or a plurality of spectrally resolved Raman images. The resultant spatially accurate wavelength resolved Raman images are then processed using reference databases 155 or statistical techniques applicable to spectroscopic data to generate an image of relevant biological information about the sample.

The output generated by exemplary systems illustrated in FIGS. 1, 2 and 3, includes a three dimensional block of data or a hypercube with spatial dimensions in the x and y dimensions and wavelength or frequency in the z dimension. From the hypercube, a plurality of spectra for each pixel of the image plane may be selected for analysis or a plurality of spatially accurate wavelength resolved images may be selected for analysis. The data contained within the hypercube may be analyzed by multivariate (chemometric) analysis techniques such as principal component analysis, principal component regression and partial least squares modeling to generate a chemical image. The information within the chemical image includes, spatial, chemical, structural, and functional information characterizing the material under analysis.

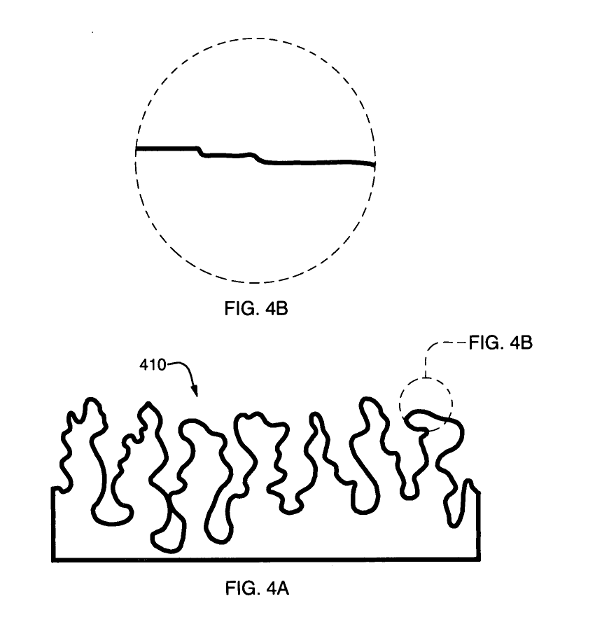

With reference to FIG. 4, a schematic diagram illustrates a SERS surface having enhancing structures 410 distributed across the surface where the surface includes a two dimensional area of at least 5×10⁵ nm². In one embodiment, the enhancing structures are uniformly distributed across the surface. In another embodiment, the enhancing structures will have a size of 100-1000 nm size, in at least one dimension of height or width or length, which are uniformly distributed over the surface. An enhancing structured SERS surface is shown in contrast to a nano-structured surface 420 having structure on a significantly smaller scale, of 0.1 to 10 nm. The enhancing structure SERS surface will exhibit electromagnetic enhancement and/or chemical enhancement of the Raman signal. It is envisioned that the enhancing structure SERS surface will have extended Plasmon fields to sample the intra cellular material of biological entities at micron distances from the surface. Excitation of these extended plasmons can be achieved by tuning the incident angle to optically couple to longer period optical or meso structures on the surface. The enhancing structures may be fabricated by electrochemical or vapor deposition, vapor alloy deposition or sputtering, chemical (reactive) deposition, chemical or electrochemical etching, electrochemical roughening of metal surfaces, electron-beam lithography, semiconductor lithographic fabrication methods, colloidal preparative methods and/or various combinations of these processes. In one embodiment, the enhancing structure is fabricated by etching metals from metal alloy films. In another embodiment, the enhancing structure is fabricated by electrochemically roughening a porous metal film. In another embodiment, the enhancing structure SERS surface includes a gold surface. In yet another embodiment, the enhancing structure SERS surface includes a silver surface. Methods for making enhancing structure SERS surfaces is described in U.S. Patent Publication No. 2006/0061762 which is incorporated herein by reference in its entirety.

In one embodiment, the SERS surface having a plurality of enhancing structures distributed on the surface is envisioned as a porous film showing point to point variations in signal enhancement having standard deviations of only ±15%. This is in contrast to prior art SERS substrates having point to point variations of 200% to 200,000%. In another embodiment, the enhancing structure SERS surface is envisioned as a textured metal film with areas of pores and metal film.

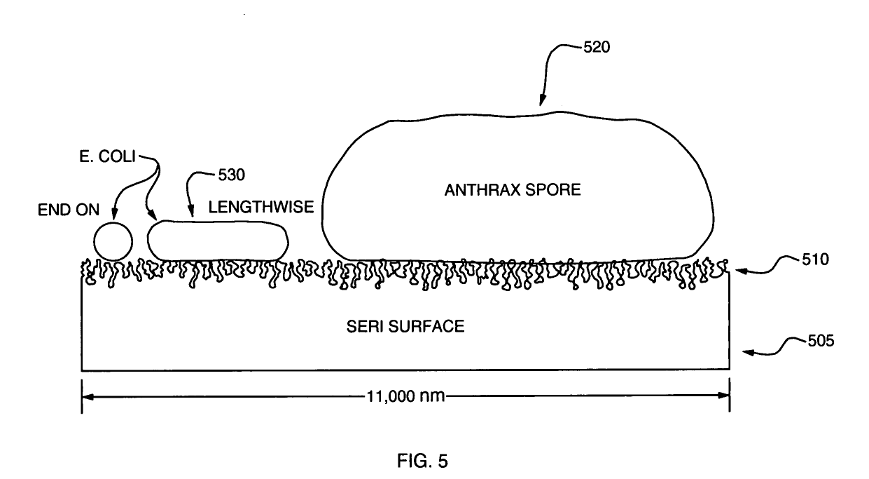

Referring to FIG. 5, a schematic diagram illustrates exemplary biological materials 520, 530 distributed on an exemplary SERS surface having enhancing structures 510 distributed across the surface 505. Representative biological entities, sizes and shape include: staphylococcus˜700 nm diameter sphere; E-coli bacteria ˜600×2000 nm shaped rod; anthrax cyst˜1000-2000 nm shaped oblong; blood cell˜2000×8000 nm shaped saucer; epithelial cells˜10000×50000 nm shaped flat blob. In one embodiment, it is envisioned that the structures will be uniformly distributed in the x- and y-directions of the SERS surface so that the surface of a biological material will have substantially homogeneous contact with the SERS enhancing structures without areas deficient of surface structures. The uniform enhancing structures SERS surface will provide substantially uniform Raman signal enhancement across its surface. For example, a uniform structure SERS surface having enhancing structures extending over 1000 nm in diameter may be used to enhance the Raman scattering signal of a staphylococcus bacterium. For example, a uniform structure SERS surface having enhancing structures extending over 3000 nm in the x-direction and 1000 nm in the y-direction may be used to enhance the Raman scattering signal of an anthrax spore. As shown in FIG. 5, the electromagnetic enhancement and/or chemical enhancement of larger biological entities will require different electromagnetic field patterns than those for small molecule bound to the surface. The localized electromagnetic field of a compact uniform structure SERS surface will likely have sufficient electromagnetic enhancements to probe inside the outermost layers of biological objects. To spatially probe deeper, requires the more extended electromagnetic fields of uniform denriditic-like structure features 410 shown in FIG. 4. In changing the incidence angle, the ratio of the long range and short range enhancements will change and allow one to discriminate between these two components of the SERS enhancement.

In one embodiment, the material includes tissue samples such as thin sections of fresh or paraffin embedded tissue. In another embodiment, the sample includes cellular samples such as those routinely obtained in Fine Needle Aspiration, urine cytology, bronchial lavage, peritoneal lavage, and cervical scraping. In another embodiment, the material has at least one dimension of length or width of at least 600 nm.

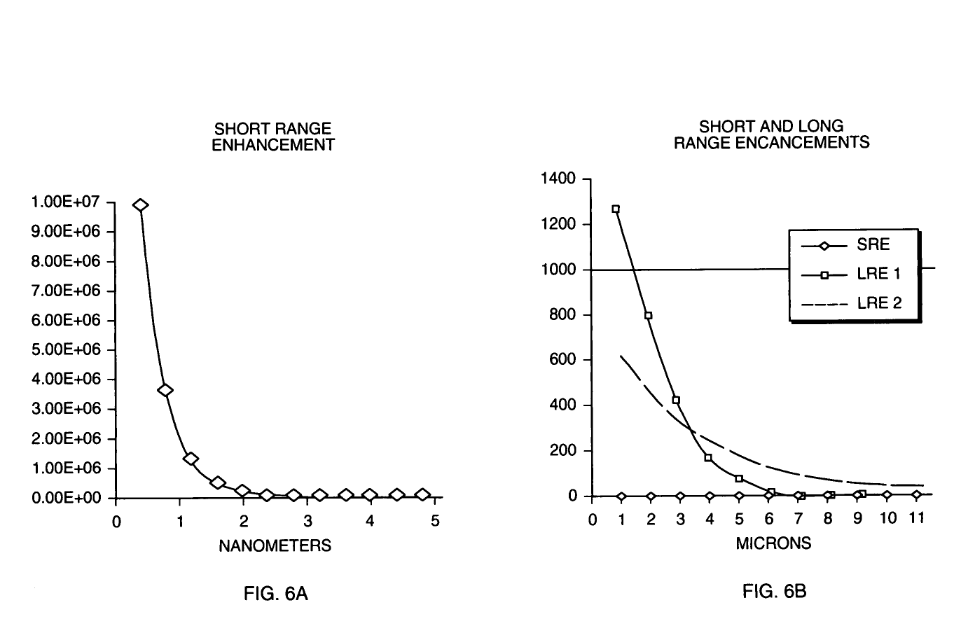

FIGS. 6A and 6B illustrates a phenomenological simulation of the Raman enhancement for a local short-range, nanostructure, chemical enhancement and much weaker longer-range field enhancements of a SERS surface. As shown in FIG. 6A, the highest short-range enhancement depends on strong local fields of a small particle, or as depicted here, a chemical effect that depends on the overlap of the wave functions of the metal site and molecule and their local electronic configuration. Associated with such wave function overlap, these enhancements die out at a distance of 5 nm from the SERS surface. With reference to FIG. 6B, longer enhancement depends on the electrodynamics of the surface structure and its shielding or lack thereof by the underlying metal or interactions with other dielectric layers. The enhancing structures of FIG. 6B have a size ranging from 100 nm to 1000 nm, in at least one dimension of height or width or length. The spatial features, such as size and shape, of the metallic particle/feature determine the length and screening of the longer range extended field. FIG. 6B shows two screening models for the longer-range field enhancement, where the electron densities from highly localized fields are scaled to reflect a different screening by the substrate. This simulation uses a screened plasmon model of the electromagnetic fields. The spatial extension of surface plasmons arising from silver grating structures are well know and have been previously observed to contribute to the total SERS enhancements

In one embodiment, the present disclosure provides for methods to image biological materials positioned laterally across the enhancing structure SERS surface so as to pinpoint the locations of organelles and more accurately detect different biochemicals within the biological material. The higher signal to noise (“S/N”) achieved will enable the detection of more subtle changes in these cellular chemicals that reflect biochemical problems, e.g., cancer or metabolic disorders. In one embodiment, the Raman signals of different biological materials are enhanced without the need for any special immuno tagging agents.

In another embodiment, volumetric imaging with an enhancing structure SERS surface will similarly enable the real space coordinates of these biological maerials and their molecular identity in cells or other biological materials. The volumetric image is obtained by collecting a plurality of spatially resolved Raman spectra and/or a plurality of spectrally resolved Raman images at a plurality of focus depths. The output generated at the plurality of focus depths is then combined to construct a volumetric image of the biological entity. While the natural localization of certain chemicals within the organelles of cells is well known, it is necessary to have the sensitivity and resolution to detect the chemicals. Otherwise harvesting of such material from many cells may be necessary to obtain sufficient material for such an analysis which is problematical if one has only a few cancer cells to work with. Characterization of the distance dependence of the enhancing structures SERS surface will allow recalibration of the actual signal levels, which spatially vary in the z-direction, and reflect the actual relative concentrations of these chemicals throughout the cell.

In yet another embodiment, the present disclosure provides for a surface which is envisioned to have a reservoir of reagent at the SERS surface biological entity interface. This surface will permit a wide range of cell membrane and cellular metabolic studies, including processes and the chemistry of cell membranes. To date this interface and its properties have been very difficult to study due to the extremely thin bilipid layer (˜60 nm) that comprises this membrane as well as the small amount of cellular biochemicals present there. It is further envisioned, that SERS surface structures having both meso-structures, 100 nm to 1000 nm in size in at least one dimension, and nano-structures, 1 nm to 10 nm in size in at least one dimension, for local and extended enhancement can allow the sampling of either or both.

In another embodiment, the present disclosure envisions the discrimination of both local and more distant biological entities using an enhancing structures SERS surface. By varying and selecting the angle of the incident light one can tune the resulting field to probe locally bound structures on the membrane of the biological object or further away from it. This difference in sampling distance essentially exploits the long and short range enhancements that can arise due to different plasmons that can be excited at off normal incidence. Further angular modulation of the incident light can allow comparisons of the two regions and the direct comparison of these different signal contributions thereby allowing each of them to be more clearly delineated. This signal modulation approach is widely known and practices to separate signals, and known as differentiated modulation or “lock-in detection.”

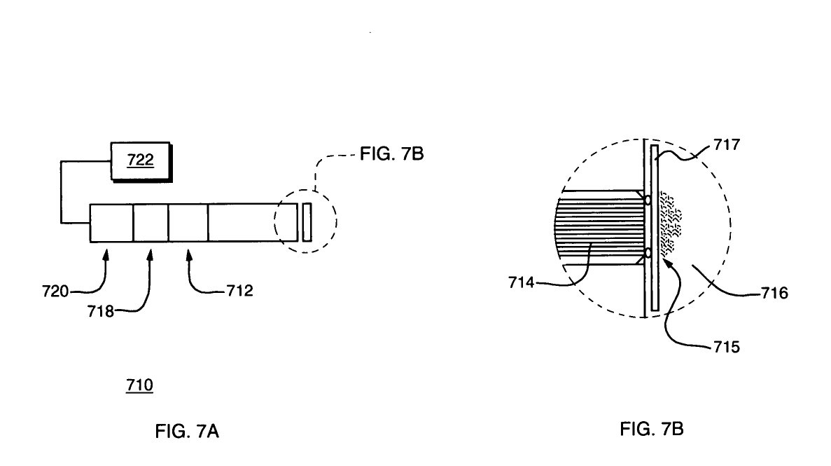

In another embodiment, the present disclosure envisions the fabrication of a device having an enhancing structures SERS surface on a transparent substrate. With reference to FIG. 7, device 710 includes a monochromatic light source 712, a plurality of optical fibers 714, a SERS surface 715, the enhanced extended field 716, a transparent substrate 717, a two dimensional tunable filter 718, a two dimensional detector 720 and a processor 722. The optical fibers 714 transmit substantially monochromatic light to a sample and receive Raman scatter photons produced by the sample. The SERS surfaces 716 have structures distributed on the exterior of the substrate surface 717 wherein the surface includes a two dimensional area of at least 5×10⁵ nm². In one embodiment, the structures are uniformly distributed across the surface. In another embodiment, the enhancing structures have a size ranging from 100 nm to 1000 nm, in at least one dimension of height or width or length. Two dimensional tunable filter 718 filters the Raman scattered photons in a plurality of predetermined wavelength bands. Two dimensional detector 720 detects the filtered Raman scattered photons, in a spatially accurate manner, and generates outputs in response to the Raman scattered photons in a plurality of predetermined wavelength bands. Processor 722 combines the outputs of the two dimensional detector to produce a plurality of spatially accurate wavelength resolved Raman images of the sample. Device 710 allows a projection mode of illumination and Raman collection in a backscattering geometry permitting illumination and detection of a solid object upon which the probe is placed. As illustrated in FIG. 7, the plurality of optical fibers 714 transmit and collect the illuminating and Raman scattered light. In one embodiment, the device could be used as contact probe to be positioned or pressed into a body part of tissue during surgery to determine specific molecular characteristics. In another embodiment, the device could be used as a portable sensor probe to detect toxic powders or liquids.

In yet another embodiment, a device is envisioned having a SERS surface on a soft pliable substrate which would allow a disposable sampling head used for handle held units or in particular for disposable probes that could be discarded after use by a patient. The use of this device would allow both a signal enhancement as well as a discardable surface for one time use on patients. For such patient applications it would further be desirable to have an optically transparent protective layer over the outer SERS surface which may come into contact with the patent's biological material. The protective cover would protect the SERS surface from degradation arising in the environment. The protective layer should ideally be thin to minimize separation of the material of interest from the SERS roughness features. Also, the protective layer should have a simple Raman spectrum to avoid confounding the Raman signal from the material of interest.

In another embodiment, it is envisioned that the enhancing structures SERS surface may be used for measurement of Raman optical activity and of weaker Raman features associated with protein chirality. Raman chirality, while having an extremely weak signal, can provide unique and novel information about protein folding. Speeding such measurements up by a thousand fold would enable a measurement that took a week to take 10 minutes. Alternately the ability to produce Raman enhancements over an area could enable measurement of spatially resolved Raman optical activity. This could enable pinpointing locations in a cell where unusual Raman optical activity arises. In addition erroneous protein folding in not only cells but in specific organelles will also be more efficiently detected using such surfaces that allow sub cellular level molecular resolution. These protein-folding problems form the basis of several diseases, such as Alzheimer's and mad cow disease. Due to the need to maintain circular polarization for Raman optical activity, periodic structures will likely inhibit the Raman signal. It is envisioned that random structures will not interfere or significantly reduce measurement of circularly polarized Raman from such surfaces.

In yet another embodiment, reduced laser power, data acquisition time, and/or improved sensitivity is envisioned for Raman spectroscopy based studies of bio-materials due to the enhanced signal levels possible with an enhancing structure SERS surface of the disclosure. In yet another embodiment, reduced laser power or data acquisition time is envisioned for a variety of optical spectroscopy based studies of bio-materials.

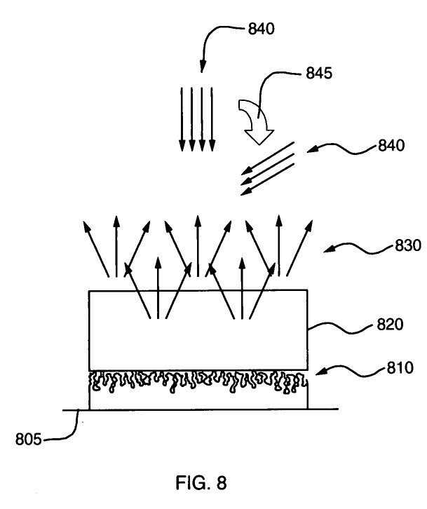

With reference to FIG. 8, an embodiment of the present disclosure illustrates a variable angle system for imaging a sample 820 deposited on an enhancing structures SERS surface 810. The sample and the SERS surface are supported on a substrate which is located along a plane 805. The sample 820 is illuminated with a monochromatic light source along an optical path 840. The optical path 840 is at an angle of illumination 845 other than 90° with respect to the substrate plane 805. The angle of illumination 845 may be varied from about 0° with respect to the substrate plane 805 to 89° with respect to the substrate plane.

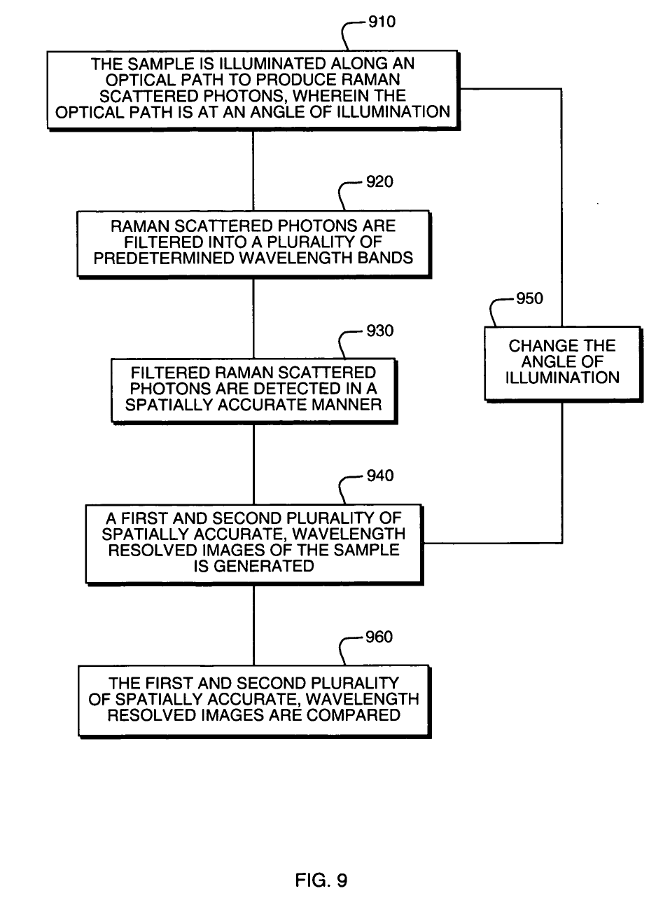

In one embodiment, the present disclosure uses the system illustrated in FIG. 8 for measuring spatial and spectral information from a sample deposited on a meso-structured SERS surface at varying angles of illumination. With reference to FIG. 9, a flow chart is shown illustrating a method of the present disclosure. In step 910, the sample is illuminated, with monochromatic light, along an optical path producing Raman scattered photons, wherein the optical path is at a first angle of illumination, wherein the first angle of illumination is other than 90° with respect to the substrate plane. In step 920, the Raman scattered photons are filtered into a plurality of predetermined wavelength bands. In step 930, the filtered Raman scattered photons are detected in a spatially accurate manner. In step 940, a first plurality of spatially accurate, wavelength resolved images of the sample is generated. In step 950, the sample is illuminated, with monochromatic light, along an optical path producing Raman scattered photons, wherein the optical path is at a second angle of illumination, wherein the second angle of illumination is other than 90° with respect to the substrate plane. Steps 920, 930 and 940 are then repeated to generate a second plurality of spatially accurate, wavelength resolved images. In step 960, the first plurality of spatially accurate, wavelength resolved images are compared to the second plurality of spatially accurate, wavelength resolved Raman images.

The present disclosure may be embodied in other specific forms without departing from the spirit or essential attributes of the disclosure. Accordingly, reference should be made to the appended claims, rather than the foregoing specification, as indicated in the scope of the disclosure. Although the foregoing description is directed to the preferred embodiments of the disclosure, it is noted that other variations and modification will be apparent to those skilled in the art, and may be made without departing from the spirit or scope of the disclosure.

What is claimed:

1. A method comprising:
a) providing a SERS surface having a plurality of enhancing structures distributed on the surface wherein the surface includes a two dimensional area of at least 5×10⁵ nm²;
b) depositing a biological material on the SERS surface;
c) illuminating, via a monochromatic light source, the biological material on the SERS surface to thereby produce Raman scattered photons;
d) filtering the Raman scattered photons from the area into a plurality of predetermined wavelength bands;
e) detecting, via a two-dimensional array detector, the filtered Raman scattered photons, in a spatially accurate manner, and
f) combining the results of filtering and detecting to produce a plurality of spectrally resolved Raman images of the biological material.

2. The method of claim 1, wherein the enhancing structures are uniformly distributed over the surface.

3. The method of claim 1, wherein the enhancing structures have a size, in at least one dimension of height, width and length, ranging from 100 nm to 1000 nm.

4. A method comprising:
a) providing a SERS surface having a plurality of enhancing structures distributed on the surface wherein the surface includes a two dimensional area of at least 5×10⁵ nm²;
b) depositing a biological material on the SERS surface;
c) illuminating, via a monochromatic light source, the biological material on the SERS surface to thereby produce Raman scattered photons;
d) filtering the Raman scattered photons into a plurality of predetermined wavelength bands;
e) detecting, via a two-dimensional array detector, the filtered Raman scattered photons, in a spatially accurate manner, and generating output;
f) collecting output of said biological material deposited on the SERS surface in a plurality of focus depths by repeating steps a-e; and
g) combining said collected output to construct a volumetric image of said biological material deposited on the SERS surface.

5. The method of claim 1, wherein the enhancing structures are uniformly distributed over the surface.

6. The method of claim 1, wherein the enhancing structures have a size, in at least one dimension of height, width and length, ranging from 100 nm to 1000 nm.

7. A method comprising:
a) providing a SERS surface having a plurality of enhancing structures distributed on the surface wherein the surface includes a two dimensional area of at least 5×10⁵ nm²;
b) depositing a biological material on the SERS surface;
c) illuminating along a first optical path, via a monochromatic light source, the biological material on the SERS surface to thereby produce Raman scattered photons, along a second optical path, wherein the first optical path is at an oblique angle with respect to the second optical path;
d) filtering the Raman scattered photons into a plurality of predetermined wavelength bands;
e) detecting, via a two-dimensional array detector, the filtered Raman scattered photons, in a spatially accurate manner, and
f) combining the results of filtering and detecting to produce a plurality of spectrally resolved Raman images of the biological material.

8. The method of claim 1, wherein the enhancing structures are uniformly distributed over the surface.

9. The method of claim 1, wherein the enhancing structures have a size, in at least one dimension of height, width and length, ranging from 100 nm to 1000 nm.

10. A method comprising:
a) providing a SERS surface having one of the following a plurality of nanostructures distributed on the surface and a plurality of mesostructures distributed on the surface;
b) depositing a biological material on the SERS surface;
c) providing a reagent between the biological material and the SERS surface;
d) illuminating, via a monochromatic light source, the biological material on the SERS surface to thereby produce Raman scattered photons;
e) filtering the Raman scattered photons into a plurality of predetermined wavelength bands;
f) detecting, via a two-dimensional array detector, the filtered Raman scattered photons, in a spatially accurate manner, and
g) combining the results of filtering and detecting to produce a plurality of spectrally resolved Raman images of the biological material.

11. The method of claim 10 wherein said nanostructures have a size, in at least one dimension of height, width and length, ranging from 0.1 nm to 10 nm and said mesostructures have a size, in at least one dimension of height, width and length, ranging from 100 nm to 1000 nm.

12. A method comprising:
a) providing a SERS surface having a plurality of enhancing structures distributed on the surface wherein the surface includes a two dimensional area of at least 5×10⁵ nm²;
b) depositing a biological material on the SERS surface;
c) illuminating, via a monochromatic light source, the biological material on the SERS surface to thereby produce Raman scattered photons, said illumination source is located in front of the transparent substrate;
d) collecting, via an optical lens, the Raman scattered photons, wherein the optical lens is located in back of the transparent substrate;
e) filtering the Raman scattered photons into a plurality of predetermined wavelength bands;
f) detecting, via a two-dimensional array detector, the filtered Raman scattered photons, in a spatially accurate manner, and
g) combining the results of filtering and detecting to produce a plurality of spectrally resolved Raman images of the biological material.

13. The method of claim 1, wherein the enhancing structures are uniformly distributed over the surface.

14. The method of claim 1, wherein the enhancing structures have a size, in at least one dimension of height, width and length, ranging from 100 nm to 1000 nm.

15. A method comprising:
a) providing a SERS surface having a plurality of enhancing structures distributed on the surface wherein the surface includes a two dimensional area of at least 5×10⁵ nm²;
b) depositing a material on the SERS surface wherein said material has at least one dimension of length or width of at least 600 nm;
c) illuminating, via a monochromatic light source, the material on the SERS surface to thereby produce Raman scattered photons;
d) filtering the Raman scattered photons from the area into a plurality of predetermined wavelength bands;
e) detecting, via a two-dimensional array detector, the filtered Raman scattered photons, in a spatially accurate manner, and
f) combining the results of filtering and detecting to produce a plurality of spectrally resolved Raman images of the material.

16. The method of claim 1, wherein the enhancing structures are uniformly distributed over the surface.

17. The method of claim 1, wherein the enhancing structures have a size, in at least one dimension of height, width and length, ranging from 100 nm to 1000 nm.

18. An apparatus comprising:
a monochromatic light source;
a plurality of optical fibers, wherein said fibers transmit substantially monochromatic light to a sample and receive Raman scatter photons produced by the sample;
a transparent substrate;
a SERS surface having enhancing structures distributed on the surface wherein the surface includes a two dimensional area of at least 5×10⁵ nm² and the enhancing structures have a size, in at least one dimension of height, width and length, ranging from 100 nm to 1000 nm;
a tunable filter for filtering the Raman scattered photons into a plurality of predetermined wavelength bands;
a two dimensional detector for detecting the filtered Raman scattered photons, in a spatially accurate manner, and generates outputs in response to the Raman scattered photons in a plurality of predetermined wavelength bands;
a processor that combines the outputs of the two dimensional detector to produce a plurality of spectrally resolved Raman images of the sample.
